(19) United States
(12) Patent Application Publication
(10) Pub. No.: US 2009/0239107 A1
(43) Pub. Date: Sep. 24, 2009

(54) Gas Storage system for a fuel cell and method for using the same

(76) Inventors: Zhijun Gu, Shanghai (CN); Xuming Zhu, Shanghai (CN)

Correspondence Address: WOODS, ROGERS, P.L.C., 1505 LONDON ROAD, CHARLOTTESVILLE, VA, 22902-8681, US

(21) Appl. No.: 12/405,260

(22) Filed: Mar. 17, 2009

(30) Foreign Application Priority Data
Mar. 19, 2008 (CN) 200810034843.8

(51) Int. Cl. H01M 8/04; H01M 2/02

(52) U.S. Cl. 429/13; 429/34

(57) ABSTRACT

The invention relates to a gas storage system for a fuel cell system comprising at least one gasbag whose volume increases and decreases with the increase and decrease in the amount of hydrogen contained therein, at least two hydrogen interface valves that are located at two ends of the gas storage system, an anode gas chamber for the fuel cell and pipes configured to interconnect the anode gas chamber of the fuel cell, the gasbag and the hydrogen interface valves, wherein the ratio of the capacity of the gas storage system including the gasbag before gas inflation to the capacity after full gas inflation is less than 50%. The invention also relates to a method for using the gas storage system, which comprises charging and discharging the gasbag at different ends thereof. The advantages of the present invention include high hydrogen purity after inflation, perfect effect in purging impure gas on discharging, and relatively stable Nernst voltage on operation when compared with that of the prior art.

### TECHNICAL FIELD

The invention relates to the field of fuel cells, and in particular relates to a gas storage system for a fuel cell and to a method for using the same.

### TECHNICAL BACKGROUND

Chinese patent 200510111373.7 generally disclosed a hydrogen-powered toy car, whose hydrogen storage device included at least one gasbag and at least one inlet and at least one outlet for hydrogen, wherein the volume of the gasbag of the hydrogen storage device increased/decreased together with the increase/decrease of the amount of hydrogen contained therein.

The prior art disclosed above has the advantages of fewer parts, a compact structure, a small volume, rapid speed, and being able to be used as a toy or a teaching aid. However, it also has the following disadvantages.

The gasbag always has a base capacity before gas inflation. The pipes running between the inlet/outlet for hydrogen and the gasbag as well as the fuel cell have some further capacity, while the anode area of the fuel cell also had some capacity. After the above-described hydrogen-powered toy car remained dormant for a long time, air would slowly penetrate through the gasbag and walls of the pipes, partially filling the capacity described above. Therefore, when it was inflated with hydrogen for use again, the hydrogen would be mixed with air, leading to a decrease of purity. Although there is no need to worry about the risk of explosion due to the extremely small amount thereof, nitrogen in the air would flow into the fuel cell along with the hydrogen stream and would collect on the surface of the anode, reducing the level of hydrogen activity as well as the Nernst voltage, thereby resulting in a remarkable deterioration of the operation performance of the toy car.

The purity of hydrogen could be improved by performing multiple cycles of full hydrogen inflation and hydrogen discharge. However, the ratio of the capacity of the gas storage system including the gasbag within it before inflation to the capacity thereof when fully inflated is more than 50%, or can be even more than 70%, so the dilution resulting from the air is less desirable. Meanwhile, where there are only one or two hydrogen inlets/outlets which are adjacent to the analysis site for the system, gas entering later would exit earlier when discharging hydrogen, which also makes the dilution efficiency less desirable.

### SUMMARY OF THE INVENTION

The technical issues to be solved by the present invention are to overcome the defects of poor operation performance due to the decrease of hydrogen purity as described in the background and to provide a gas storage structure for a fuel cell system and a method for using the same.

The present invention has solved the above technical issues as follows.

A gas storage system for a fuel cell is provided, which includes at least one gasbag and at least two hydrogen interface valves, wherein the gasbag's volume will increase/decrease together with the increase/decrease of the amount of hydrogen contained therein. The gas storage system also comprises an anode gas chamber for the fuel cell and pipes configured to interconnect the fuel cell's anode gas chamber, the gasbag and the hydrogen interface valves. The ratio of the capacity of the gas storage system including the gasbag therein before gas inflation to the capacity thereof when fully gas-charged is less than 50%. At least two hydrogen interface valves are located at two ends of the gas storage system at the analysis site.

The gasbag can be filled with a material which is chemically inert to hydrogen under ambient temperature and pressure. The term “capacity” as used in the last paragraph, whether referring to the status before gas charging or when fully gas-charged, never includes the fill material, and should be translated as effective gas capacity.

The filling material which is chemically inert to hydrogen under ambient temperature and pressure may be plastic.

The plastic may be ABS.

The connection between the gasbag and other parts may include two interfaces, and their corresponding openings inside the gasbag corresponding to the two interfaces may be located at two ends of the gasbag.

One sub-scheme is as follows: the two interfaces and their corresponding openings inside the gasbag are located at two different ends of the gasbag.

The other sub-scheme is as follows: the two interfaces are located at the same end of the gasbag, while the two corresponding openings inside the gasbag are located at two different ends of the gasbag, respectively.

The anode gas chamber of the fuel cell is connected with the other parts of the gas storage system. The chamber may have two interfaces which are disposed at two ends of the anode gas chamber of the fuel cell.

Hydrogen is inflated through one of the two hydrogen interfaces until the gasbag is partly or fully inflated. Then the other one of the two hydrogen interfaces is opened until the gasbag deflates to its uninflated capacity. Afterwards hydrogen is supplied to the first hydrogen interface once more in preparation for use or to be followed by another discharging.

The inflated capacity is more than two times the uninflated capacity, and the two hydrogen inlets/outlets are at two separate ends of the gas storage system at the analysis site. Consequently, after the first gas inflation and discharging, the impure gas originally there will have already been substantially expelled. However, because of the diffusion of gases and impure gas remaining in some areas, the purity of the hydrogen in the gas storage system may not have reached the level required for hydrogen inflation. After completing two purge procedures involving inflation and discharge of gas, the purity of the hydrogen in the gas storage system reaches substantially the purity required to be a source for hydrogen inflation.

The positive advancements of the invention are that it can provide advantages including high hydrogen purity after gas inflation, perfect effect in purging impure gas during gas discharging, and a relatively stable Nernst voltage on operation when compared with that of the prior art.

### BRIEF DESCRIPTION OF THE DRAWINGS

FIG. 1 is a schematic view showing a first example of a gas storage system according to the invention.

FIG. 2 is a schematic view showing a second example of a gas storage system according to the invention.

### DETAILED DESCRIPTION OF THE INVENTION

A detailed description of the present invention is provided herein below with reference to the drawings, but the present invention is not limited thereby.

### EXAMPLE 1

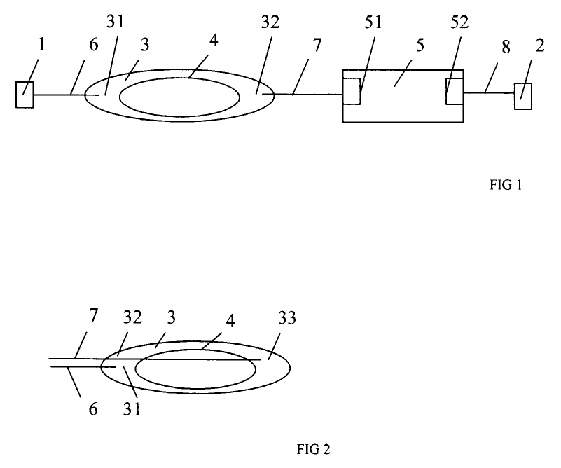

With reference to FIG. 1, the system includes hydrogen interface valve 1, hydrogen interface valve 2, gasbag 3 and fuel cell 5.

Gasbag 3 is expandible and can expand after gas inflation. The inside of gasbag 3 is filled with plastic piece 4. Since plastic piece 4 occupies quite a large volume, the characteristic of “less than 50%” mentioned in the summary of invention is thus realized.

One interface 31 and the other interface 32 of gasbag 3 are located at two separate ends of gasbag 3, and the distance between the two interfaces is approximately the base length before gas inflation.

One interface 51 of fuel cell 5 and the other interface 52 are located at two separate ends of the anode gas chamber of the fuel cell.

Hydrogen interface valve 1 is connected with one interface 31 of gasbag 3 through pipe 6, thus the opening inside the gasbag corresponding to interface 31 is located where the interface 31 is disposed. The other interface 32 of gasbag 3 is connected with one interface 51 of fuel cell 5 through pipe 7, thus the opening inside gasbag 3 corresponding to interface 32 is located where interface 32 is disposed. The other interface 52 of fuel cell 5 is connected with hydrogen interface valve 2 through pipe 8.

Prior to each use, hydrogen is inflated through hydrogen interface valve 1 until gasbag 3 is fully charged, then hydrogen interface valve 2 is opened to discharge gas until gasbag 3 deflates to its uninflated capacity. The above steps are repeated at least two times. Thereafter, the hydrogen gas system is ready for use. The system can be used continuously for many times during a short period and there is no need to inflate and discharge gas again.

### EXAMPLE 2

With reference to FIG. 2, the descriptions of example 1 are followed with the exception that pipe 6 and pipe 7 are connected into gasbag 3 through interface 31 and interface 32 located at the same end of gasbag 3, but interface 32 extends to the corresponding opening 33 at the other end of gasbag 3 through a pipe inside gasbag 3. As a result, example 2 can produce the same effect as that of example 1.

Modification is made to toy cars described in the technical background of Chinese Patent 200510111373.7 by employing example 2, and comparative experiments before and after modification can be performed.

Before modification, the toy cars can occasionally operate 5 minutes, but during the fifth minute, the speed slows down from an initial 5 km/hour to 2 km/hour and the toy cars stop soon thereafter while the gas inside the gasbag is not completely consumed.

After modification, the toy cars can operate for more than 5 minutes every time, and the speed during the fifth minute is not less than 4.5 km/hour while the gas inside the gasbag is completely consumed.

1-9. (canceled)

10. A gas storage system for a fuel cell comprising:
at least one inflatable gasbag, each of which has a first end and an opposing second end wherein a first gasbag interface and a second gasbag interface are located at the first end and the second end, respectively;
at least one filling means placed inside of each said gasbag for displacing more than 50% of the inflated volume of said gasbag;
at least two hydrogen interface valves;
a first pipe connecting a first of said hydrogen interface valves to one end of said gasbag at a first gasbag interface;
a fuel cell having an anode gas chamber;
a first fuel cell interface located on one end of said fuel cell extending into the anode gas chamber;
a second fuel cell interface located on the opposite end of said fuel cell extending into the anode gas chamber;
a second pipe connecting the end of said gasbag opposite said first hydrogen interface valve at a second gasbag interface to said first fuel cell interface; and
a third pipe connecting said second fuel cell interface to a second of said hydrogen interface valves.

11. The gas storage system of claim 10, wherein said filling means is a material which is chemically inert to hydrogen under ambient temperature and pressure.

12. The gas storage system of claim 11, wherein said filling means is plastic.

13. The gas storage system of claim 12, wherein the plastic is acrylonitrile butadiene styrene (ABS).

14. The gas storage system of claim 11 which provides a stable Nernst voltage when the fuel cell is in operation.

15. A gas storage system for a fuel cell comprising:
at least one inflatable gasbag, each of which has a first end and an opposing second end wherein a first gasbag interface and a second gasbag interface are both located on one end thereof;
at least one filling means placed inside of each said gasbag for displacing more than 50% of the inflated volume of said gasbag;
at least two hydrogen interface valves;
a first pipe connecting a first of said hydrogen interface valves to the first end of said gasbag at the first gasbag interface;
a fuel cell having an anode gas chamber;
a first fuel cell interface located on one end of said fuel cell extending into said anode gas chamber;
a second fuel cell interface located on the opposite end of said fuel cell extending into said anode gas chamber;
an opening inside said gasbag at the opposing second end thereof to which the second gasbag interface is operably connected;
a second pipe extending from said second gasbag interface connect to said first fuel cell interface; and
a third pipe connecting said second fuel cell interface to a second of said hydrogen interface valves.

16. The gas storage system of claim 15, wherein said filling means is a material which is chemically inert to hydrogen under ambient temperature and pressure.

17. The gas storage system of claim 16, wherein said filling means is plastic.

18. The gas storage system of claim 17, wherein the plastic is acrylonitrile butadiene styrene (ABS).

19. The gas storage system of claim 16 which provides a stable Nernst voltage when the fuel cell is in operation.

20. A method for providing substantially pure hydrogen gas to a fuel cell using a gas storage system having at least one inflatable gasbag containing a filler which displaces more than 50% of the inflated volume of the gasbag wherein the gasbag is connected to at least two hydrogen interface valves at least one of which is connected to a source of hydrogen gas comprising:
deciding how many cycles of inflation and deflation of the gasbag to purge impure gas within the gasbag are desired wherein a minimum of two cycles is mandatory;
releasing hydrogen into the gasbag through any one of the hydrogen interface valves until the gasbag is inflated to the desired level which may be partial or complete;
opening a different one of the hydrogen interface valves to allow hydrogen to escape from the gasbag until the gasbag completely deflates;
determining the number of cycles which have been completed; and
if the desired number of cycles has not been completed, returning to releasing.
